(19) United States
(12) Patent Application Publication
(10) Pub. No.: US 2021/0004986 A1
(43) Pub. Date: Jan. 7, 2021

(54) ART COLOR COORDINATING MANUFACTURING METHOD

(71) Applicant: Lawrence D. Simmons, JR., Edina, MN (US)

(72) Inventor: Lawrence D. Simmons, JR., Edina, MN (US)

(21) Appl. No.: 16/780,385

(22) Filed: Feb. 3, 2020

Related U.S. Application Data
(60) Provisional application No. 62/870,424, filed on Jul. 3, 2019.

(51) Int. Cl. G06T 7/90; G06T 11/00; B44D 3/00

(52) U.S. Cl. CPC G06T 7/90; G06T 2207/10024; B44D 3/003; G06T 11/001

(57) ABSTRACT

An art color coordinating manufacturing method includes the acquiring of a principal color and then acquiring coordinating colors of the principal color. A design is selected and modified with the coordinating colors to define an output image such that the output image coordinates with the principal color. The output image is then printed to be used as an art piece.

### CROSS-REFERENCE TO RELATED APPLICATIONS

I hereby claim the benefit under 35 U.S.C. Section 119(e) of U.S. Provisional application 62/870,424 filed on Jul. 30, 2019, and U.S. Provisional application 62/799,866 filed on Feb. 1, 2019.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to system for producing color coordinated art and more particularly pertains to a new system which acquires a color or color palette from which an art piece is created to ensure that it harmonizes with the color or color palette. The acquired color being selected, for example, from a wall color such that the resultant art piece color palette will coordinate with the wall color.

Generally, when a person is color coordinating a space, the intention is to select coordinating color combinations. The objects for which colors may be chosen include virtually all elements found within a space, and, should that space being an interior living space for example, may include flooring, carpeting, rugs, wall paint, trim, furniture, lighting, accessories, etc., and wall hung articles, specifically art. Currently, the person must select what color palette will be used to form their base colors, such as for flooring/floor coverings, furniture and wall color(s). After this has been determined, the person will accessorize with art, throw pillows, lamps and the like. The person will be limited in two ways. The first is that even highly trained interior decorators do not always correctly select accessories having the correct coordinating colors. This may be due to unforeseen lighting effects, accessories not precisely matching their intended colors, and, quite often, human error. Second, not only is matching the coordinating colors difficult, but even if the accessories do match, they may not impart the intended effect on the living space. One person may require a more vibrant art piece while another wishes for a more subdued color palette. It is virtually impossible to completely please all people and thus the user of the living space must settle for the closest approximation to what they actually desire.

While it can be difficult even for the trained interior decorator to approximate the needs and desires of their clients with coordinating colors, it is extraordinarily difficult for a lay person to decorate their own living space in a color coordinating manner without numerous episodes of trial and error. A person thoroughly trained in selling art and accessories, at a point of sale, may offer assistance to the lay person, but of course the sales person cannot know with exact specificity the color palette to be worked with and, even if color can be determined, is still thereafter constrained by a limited inventory of art selections.

From the above, all persons, and the average shopper in particular, finds it very difficult to match or coordinate art, accessories, wall coverings, furniture and flooring in an approximate complementary manner without great time and expense. Further, even if the colors do approach being precisely coordinating, the odds that the art will entirely match their taste or “feel” they desire are very low. Therefore, the system discussed herein not only coordinates with a principal, i.e. selected, color by precisely creating the color palette from the principal color but also can create art or patterns with the color palette that may be used for walls, rugs, pillow coverings and the like to ensure that the end user has a correctly matched color scheme as well as fulfilling their aesthetic requirements. The color palette may comprise color schemes that are complimentary, split-complementary, analogous, etc. to the principal color to ensure coordination with the principal color. The system may further be used to assist a person in selecting the correct colors for walls, flooring and furniture fabrics once a principal color has been selected, or the system may select the correct base colors to be used from a principal color selected from a piece of art to ensure that the art will match the base colors.

More particularly for example, a template for an art piece may have its colors altered to adhere to the coordinating requirement while at the same time utilizing the coordinating colors in such a manner that the resultant art is reflective of a desired mood/feel for the living space. That is, a single art template may have its color altered in a nearly infinite number of ways while retaining the underlying template. This is particularly true with abstract pieces which can take on any number of appearances by simply altering its color scheme to sync with user preferences. Thus, while in one case a user may desire a vibrant art piece with bright colors, another may have a living space that necessitates something more subdued with pastel colors. Both the bright and pastel colors are coordinating to the same underlying color palette, but the two art pieces will appear dramatically different with respect to each other and will alter the appearance of the living space in dissimilar ways. Most essentially the system allows the user to coordinate the art and colors around their desired color palette. Subsequently, a user of the system can ensure that they can decorate a space, being it a living, work or other space, in such a manner that a pleasing aesthetic, from a color perspective, is ensured.

### (2) Description of Related Art Including Information Disclosed Under 37 CFR 1.97 and 1.98

The prior art relates to systems wherein pre-manufactured art is matched as close to possible to a complimentary color palette. In such a system, the user is confined to a finite set of prints in the desire to match the print to the color palette but can only approximate this result. Moreover, the art may not entirely fulfill the aesthetic qualities required or desired by the user.

### BRIEF SUMMARY OF THE INVENTION

An embodiment of the disclosure meets the needs presented above by generally comprising the acquiring of a principal color and then acquiring coordinating colors of the principal color. A design is selected and modified with the coordinating colors to define an output image such that the output image coordinates with the principal color.

The output image is then printed to be used as an art piece.

In another embodiment, a user selects an image and obtains principal and/or coordinating colors from the image. The principal and/or coordinating colors are then used to identify and acquire a paint that coordinates with or matches the principal and/or coordinating colors.

In yet another embodiment, a principal color or a coordinating color of the principal color is first acquired. Cataloged artwork stored in a database, which incorporates the principal color or the coordinating color, is identified and searched, wherein the artwork include numerous pieces of art having the desired color. One of the artwork is then selected and printed to be utilized as an art piece.

There has thus been outlined, rather broadly, the more important features of the disclosure in order that the detailed description thereof that follows may be better understood, and in order that the present contribution to the art may be better appreciated. There are additional features of the disclosure that will be described hereinafter, and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a flow chart an art color coordinating manufacturing method according to an embodiment of the disclosure.

FIG. 2 is a flow chart of an embodiment of the disclosure.

FIG. 3 is a flow chart of an embodiment of the disclosure.

FIG. 4 is a flow chart of an embodiment of the disclosure.

### DETAILED DESCRIPTION OF THE INVENTION

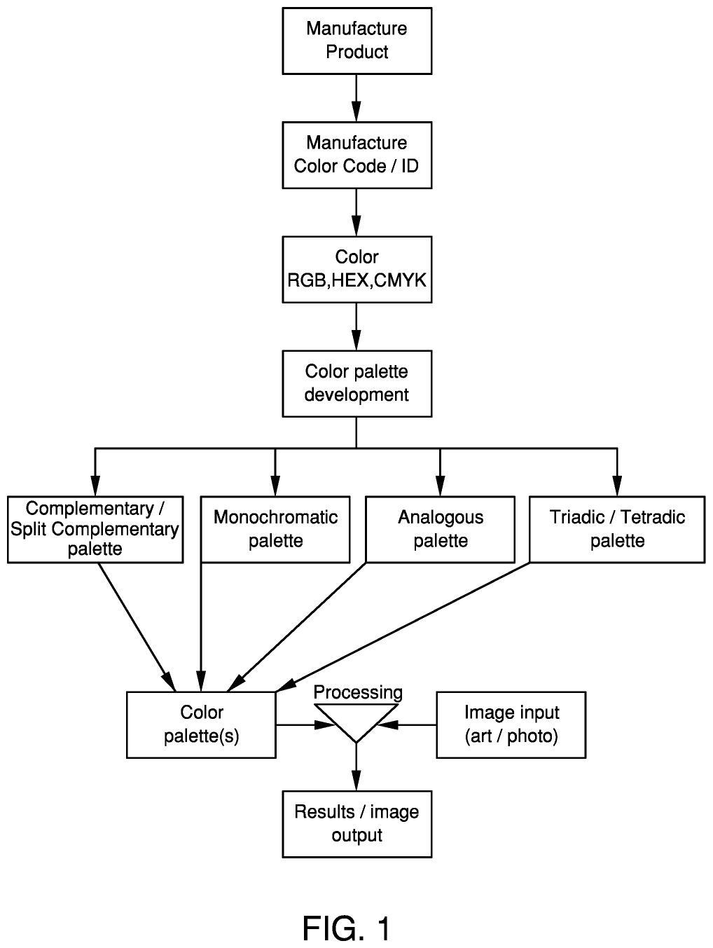

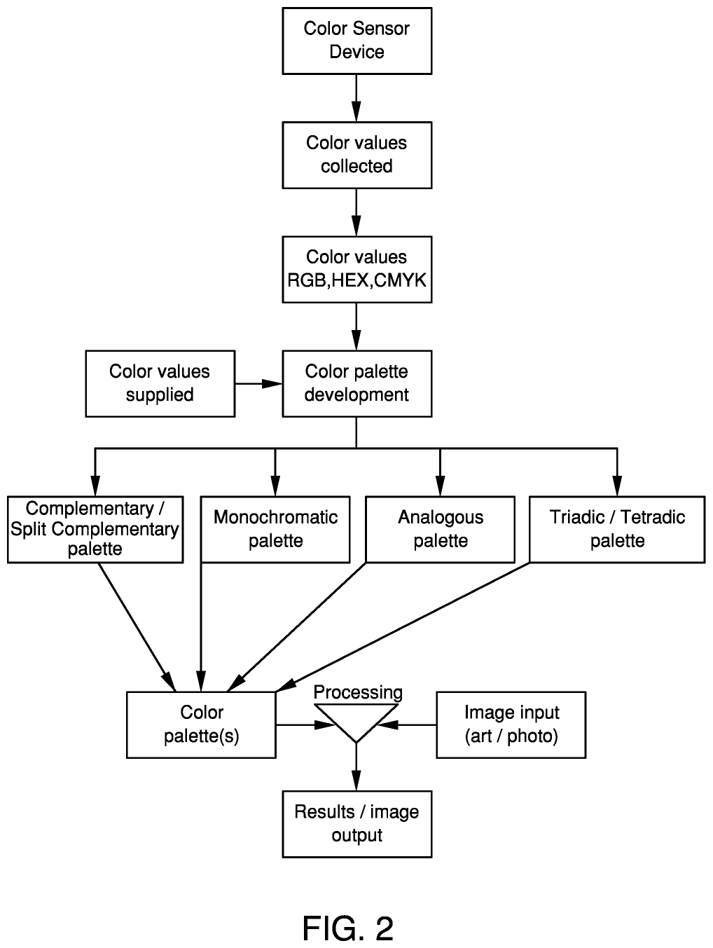

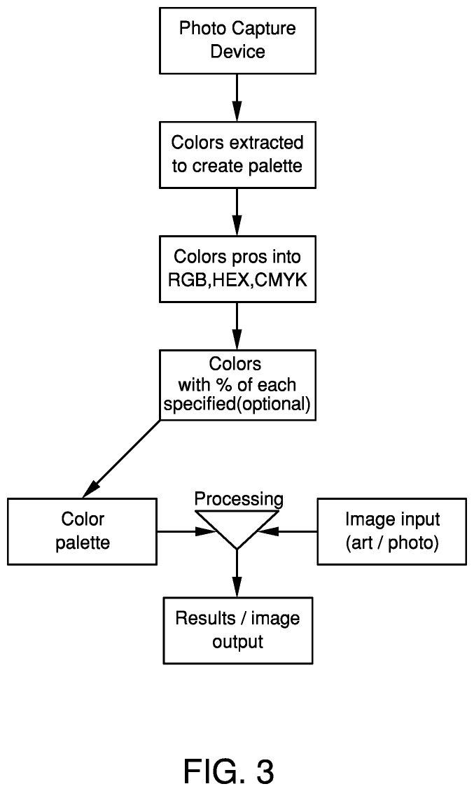

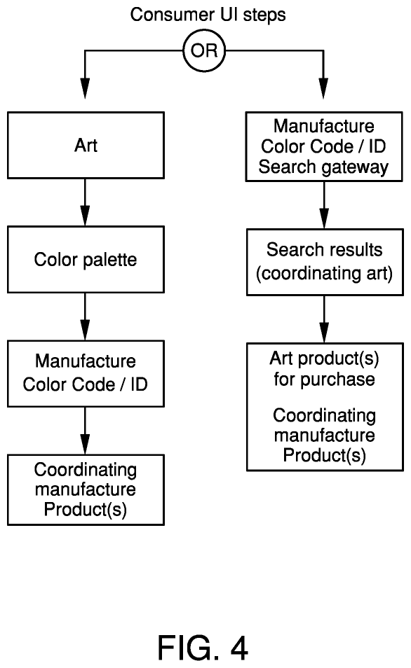

With reference now to the drawings, and in particular to FIGS. 1 through 4 thereof, a new system for producing color coordinated art embodying the principles and concepts of an embodiment of the disclosure and generally designated by the reference numeral 10 will be described.

As best illustrated in FIGS. 1 through 4, the art color coordinating manufacturing method 10 generally comprises a system or method that is designed to assist a customer, or user, in coordinating or matching artwork with an acquired color. The color may be acquired in any number of ways including imaging the color by photograph, color sensor, scanning a provided color swatch, utilizing manufacturer color codes and the like.

The user will be provided with numerous artwork templates or designs which can be viewed on a website, cellular phone application, in printed media such as catalogs, and the like showing previously created digital art images based upon the underlying designs. The user selects the desired design to act as the base template. The designs may be numerous but may be placed in general categories such as, for example, bold, geometric, theme, abstract, landscape, architectural and the like.

The user provides the color to the system and may also submit a design to the system. The system includes a computer having electronic storage thereon containing the designs and numerous colors and color palettes. The computer will be programmed with an algorithm, utilizing known color principles, which matches coordinating colors to the selected color or color palette and then applies the coordinating colors to the design. The coordinating colors may be modified such as increasing the amount of some coordinating colors and lessening the amount of others on the created image, as desired by the user. The levels of the colors may also be adjusted and this may include the luminance, saturation and brightness levels to ensure the resultant image has contrast with the selected color. Essentially, the user may alter the colors to their liking, but the system will select coordinating colors to ensure overall image balance with the provided color. Once the created image is finalized by the user, the system will print the created image such that it can be used as a piece of art.

Art color content creation may be achieved, for example, by artists that are employees of an enterprise operating the system or external content contributors. Artists may include those who create the designs as well as photographers. The artists submit/upload their content for review and, once approved, the art is labeled and given a unique identifier while being stored in a database for processing. When a user selects the uploaded art, its file is sent into a deep neural network of the system as a source image (i.e. design as indicated above) along with the style or inception image to produce a new final output image utilizing the desired color or color palette.

In one example of the method, a manufacturer's color would be analyzed for its color value, such a HEX Code, CYMX, RGB, etc. Visually, the color value or hue is noted as a particular point on a color wheel and will be defined herein as the principal color. As is understood in the color art, oppositely positioned from the principal color on the color wheel is its complementary color; such as it is understood that red is complementary to green, though in this instance the colors include all variations of the primary colors of a color wheel. Adjacent to the complimentary color, which is an exact point on the color wheel, are found the split-complimentary colors. Though adjacent to each other, the complementary and split-complimentary colors are easily visually distinct colors. For example, should the principal color be a yellow/orange, the complimentary and split-complementary colors could include red violets, blues, and green blues. The selection of the split-complimentary colors may be performed by a person or a computer program utilizing well known color selection algorithms. In the above example, one would then have the principal color, the complimentary color, and two split-complementary colors (one positioned on either side of the complimentary color). To this may be added black and white for contrast. If viewed in a bar, these colors would be in the order of principal, split-complementary, complementary, split-complementary, white and black. Once these colors are selected, they are varied in luminance, saturation and brightness to create various adaptations, or shades, of each color such that they appear to blend into each other along a color graph. This forms monochromatic shades of the principal color on one end, grey scale on the other, and a multitude of color shades therebetween of the complementary and split-complimentary colors. Taken together, these blended colors form the coordinating colors to be used when coloring grayscale art to create the final, colored art piece. The coordinating colors may also be considered as accent colors which may be used as needed when selecting any object to be used within a color coordinated room. Generally speaking, the above is only one example of common color theory used for selecting aesthetically pleasing combination of colors and the system may utilize split complimentary, complimentary, analogous, triadic, and tetradic color selection methods.

As should readily be appreciated by the above, the user of the method may alter the luminance and brightness of the coordinating colors. Alternatively, instead of utilizing complementary colors, colors which are continuous with the principal color on the color wheel (adjacent to the principal color) may be utilized in the same manner to determine the coordinating colors and create a monochromatic art piece. The user may also increase usage of one particular color over another as desired to make one color appearing to be dominant within an art piece. Thus, within any art piece the principal color may be used as an accent color, the dominant color or may be absent if it is simply utilized to find complementary coordinating colors.

As can easily be appreciated, the above system may be utilized in a myriad of ways. In one embodiment, the user may select a desired artwork which was previously created by the system. Since the system created the artwork, the user can locate the principal and/or accent colors used in the artwork so that the user may then obtain the color equivalents from the color manufacturer. These color equivalents may then be used to color a room in which the artwork is to be hung to ensure that the artwork and room are complimentary to each other. That is, the user may use the color equivalents for painting walls, selecting furniture fabrics, designing rugs and pillow cases, and the like.

In another embodiment, the user first selects a paint color to be used on a wall and then looks up artwork that incorporates that color shade (or RGB, CMYX, HEX Code or equivalent color value). This color may be selected in person, online, in print, or on an application used with a cellular phone or tablet computer. The paint color may include a paint manufacturer name and/or color code which can be used as a search query gateway term for an artwork search within the system for art pieces already incorporating that specific name or color code. The user may select monochromatic, analogous, split-complementary, complementary, triadic or tetradic colors, i.e. coordinating colors. The artwork will already incorporate the correct coordinating color and is shown in electronic form before being printed. The artwork will necessarily match the paint color without concern that it might clash with other colors used within the room containing the artwork.

In yet another embodiment, images or artwork are presented online or in print form which have been produced utilizing a paint manufacturer color, or its RGB, HEX, or CMYK equivalent prior to a user's viewing thereof. The database, or server, may include manufacturer color codes, color names, product descriptions as well as art images/thumbnails, and file names accessible by a search gateway or web database query. After the user has selected the art and paint color of choice, the user then has the ability to purchase either or both of the paint color and art in a retail store or online. Alternatively, if the user has selected a paint color, the user will then have the ability to browse artwork using that color or other coordinating colors. In this manner, the user will receive not only the paint having a selected color with which to paint a room, but will be ensured that the art purchased will coordinate with the selected color.

In use, the method may be used as a point of sale for multiple types of transactions wherein a buyer wishes to find colors that compliment each other in flooring, wall coatings, wall coverings, drapes, furniture, art and accessories. The buyer may have a pre-determined principal color in mind or may be directed to one after finding an art piece, rug, or accessory that they wish to use. Regardless, once the principal color has been determined, it can be used to purchase paint, fabrics, and the like. In particular, the principal color may be utilized to determine coordinating colors that are used in either selecting or creating art pieces that include the coordinating colors. Art pieces which are being created may be altered in brightness and coloration before printing until it matches the particular desires of the buyer.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A method of producing a coordinating art piece including the steps of:
acquiring a principal color;
acquiring coordinating colors of the principal color;
selecting a design;
modifying the design with the coordinating colors to define an output image such that the output image coordinates with the principal color.

2. The method of producing a coordinating art piece according to claim 1, further including the step of printing the output image.

3. The method of producing a coordinating art piece according to claim 2, wherein the step of acquiring the principal color further includes finding a color value of a color on an image or object or receiving the color value from a manufacturer of the principal color.

4. The method of producing a coordinating art piece according to claim 1, wherein the step of acquiring coordinating colors further includes the steps of:
determining the color value of the principal color;
locating and using for the coordinating colors one or more of:
a complementary color of the principal color;
split-complementary colors of the complementary color;
analogous colors;
tetradic colors; and
triadic colors.

5. The method of producing a coordinating art piece according to claim 4, wherein the step of acquiring coordinating colors further includes the step of creating different brightness, luminance and saturation adaptations of the coordinating colors to form color shades of the coordinating colors.

6. The method of producing a coordinating art piece according to claim 5, wherein the step of acquiring coordinating colors includes the step of creating different brightness, luminance and saturation adaptations of the principal color to form monochromatic shades of the principal color within the coordinating colors.

7. The method of producing a coordinating art piece according to claim 4, wherein the step of acquiring coordinating colors includes the step of creating different brightness, luminance and saturation adaptations of the principal color to form monochromatic shades of the principal color within the coordinating colors.

8. A method of producing a coordinated art piece including the steps of:
selecting an image;
obtaining principal and/or coordinating colors from the image;
using the principal and/or coordinating colors to identify and acquire a paint complementing or matching the principal and/or coordinating colors.

9. A method of producing a coordinated art piece including the steps of:
acquiring a principal color or a coordinating color of the principal color;
searching through artwork in a database that incorporate the principal color or the coordinating color;
selecting one of the artwork; and
printing the artwork.

10. The method of producing a coordinating art piece according to claim 9, wherein the step of acquiring the principal color further includes finding a color value of the principal color from a manufacturer of the principal color.

11. The method of producing a coordinating art piece according to claim 8, wherein the step of acquiring coordinating colors further includes the steps of:
determining the color value of the principal color;
locating and using for the coordinating colors one or more of:
a complementary color of the principal color;
split-complementary colors of the complementary color;
analogous colors;
tetradic colors; and
triadic colors.

12. The method of producing a coordinating art piece according to claim 11, wherein the step of acquiring coordinating colors further includes the step of creating different brightness, luminance and saturation adaptations of the coordinating colors to form color shades of the coordinating colors.

13. The method of producing a coordinating art piece according to claim 12, wherein the step of acquiring coordinating colors includes the step of creating different brightness, luminance and saturation adaptations of the principal color to form monochromatic shades of the principal color within the coordinating colors.

14. The method of producing a coordinating art piece according to claim 10, wherein the step of acquiring coordinating colors includes the step of creating different brightness, luminance and saturation adaptations of the principal color to form monochromatic shades of the principal color within the coordinating colors.

15. The method of producing a coordinating art piece according to claim 13, wherein the step of acquiring the principal color further includes finding a color value of the principal color from a manufacturer of the principal color.
